(19) United States
(12) Patent Application Publication
(10) Pub. No.: US 2024/0336095 A1
(43) Pub. Date: Oct. 10, 2024

(54) TIRE INFLATION SYSTEM AND COMMERCIAL VEHICLE WITH A TIRE INFLATION SYSTEM AND METHOD OF OPERATING A TIRE INFLATION SYSTEM

(71) Applicant: SAF-HOLLAND GmbH, Bessenbach (DE)

(72) Inventors: Sandra Hock, Frammersbach (DE); Elmar Weber, Dülmen (DE); Simon Schäfers, Nidderau-Erbstadt (DE); Maximilian Herold, Oberzent-Beerfelden (DE); Rainer Stegmann, Hösbach (DE)

(21) Appl. No.: 18/575,930

(22) PCT Filed: Jul. 5, 2022
(86) PCT No.: PCT/EP2022/068504

§ 371 Date: Jan. 2, 2024

(30) Foreign Application Priority Data
Jul. 6, 2021 (DE) 10 2021 117 410.4

(51) Int. Cl. B60C 23/00; B60C 23/10

(52) U.S. Cl. CPC B60C 23/00309; B60C 23/10

(57) ABSTRACT

A tire inflation system, in particular for use in a commercial vehicle includes a control unit, a flow inlet, a pressure sensor, a switchable valve, in particular an electrically or magnetically switchable valve, and a flow outlet, wherein the flow inlet is configured to be connected to a compressed air system, in particular to a compressed air system of an air spring, wherein the flow outlet is configured be connected to a pressure chamber of a tire, wherein the control unit is connected to the pressure sensor and the switchable valve, wherein the pressure sensor is configured to detect a pressure at the flow outlet or at the flow inlet, wherein the control unit is configured such that the control unit opens and/or switches the switchable valve as a function of the detected pressure, in particular when the detected pressure at the flow outlet falls below a threshold value.

### BACKGROUND

The invention relates to a tire inflation system and a commercial vehicle with a tire inflation system and a method for operating a tire inflation system.

Tire inflation systems are already known from the state of the art. These are used to pump air into a vehicle tire while driving or without an external compressed air source in order to achieve the required air pressure. The known systems use the compressed air supply available on the vehicle to inflate the tire, whereby the tire pressure level above the system pressure is achieved by a pump of the tire inflation system. In order to avoid excessive pressure in the tire, a pressure control valve is used, which automatically prevents the tire(s) from being inflated when the set pressure is reached. However, the problem with the systems known from the state of the art is that the pressure control valve makes it difficult or impossible to set the target pressure of the tires.

It is therefore the object of the present invention to provide a system which enables the tires of a vehicle, in particular a commercial vehicle, to be inflated simply, easily and safely.

### SUMMARY OF THE INVENTION

According to the invention, a tire inflation system is provided, in particular for use in a commercial vehicle. Advantageously, the tire inflation system comprises a control unit, a flow input, a pressure sensor, a switchable valve, in particular an electrically or magnetically switchable valve, and a flow output, wherein the flow input is connected or connectable to a compressed air system, in particular to a compressed air system of an air spring, wherein the flow output is connected or connectable to a pressure chamber of a tire, wherein the control unit is connected to the pressure sensor and the switchable valve, wherein the pressure sensor is capable of detecting a pressure at the flow outlet or at the flow inlet, wherein the control unit is designed such that it opens and/or switches the switchable valve as a function of the detected pressure, in particular when the detected pressure at the flow outlet falls below or exceeds a threshold value. The tire inflation system is used to fill a tire with compressed air in order to achieve the required pressure in a tire. In particular, the tire inflation system is attached to a commercial vehicle, especially a commercial vehicle trailer. A commercial vehicle in the sense of the invention is in particular a vehicle which has a permissible total weight of more than 3.5 t, preferably more than 7.5 t, particularly preferably more than 15 t, and particularly strongly preferably more than 18 t. The commercial vehicle can be a trailer, in particular a semi-trailer, and/or a towed vehicle. The commercial vehicle is in particular a roadworthy and/or a road-bound vehicle. The tire inflation system according to the invention has a flow inlet, whereby air can flow into the tire inflation system through this flow inlet. Advantageously, the flow inlet is connected to a compressed air system, in particular of the commercial vehicle. The tire inflation system can be operated or filled with a compressed air system of the commercial vehicle. Advantageously, this flow inlet can also be the energy connection for the or a pressure increasing unit of the tire inflation system. A compressed air system of the commercial vehicle, which is connected to the flow inlet, can in particular be the compressed air system of the commercial vehicle, which is used to operate the or an air spring of the commercial vehicle. Alternatively or preferably, the vehicle can also have a mechanical suspension. For safety reasons, the flow inlet can have an inlet shut-off valve in order to separate the tire inflation system from the compressed air system in terms of flow. Furthermore, the tire inflation system also has a flow outlet, whereby the flow outlet is connected or can be connected to the pressure chamber of a tire or several tires. The pressure chamber of a tire in the sense of the invention is the volume enclosed by the tire, which must have a certain air pressure during operation in order to ensure proper rolling and/or operation of the tire on the road. Advantageously, the tire inflation system, which can basically also be referred to as an inflation system, is not load-dependent. In other words, the tire inflation system can be operated independently of the tire load or is independent of the tire load. The tire inflation system can therefore operate independently of the tire load. This is particularly advantageous in terms of operational safety. The flow inlet of the inflation system can be used to introduce compressed air into the tire inflation system and the flow outlet can be used to convey air from the tire inflation system into the tire or tires to be inflated. In addition to the flow inlet and the flow outlet, the tire inflation system also has a control unit, as well as at least one pressure sensor and a switchable valve. The control unit is connected to the pressure sensor (in terms of information technology) in such a way that the measured value recorded by the pressure sensor can be transmitted to the control unit in terms of information technology. In addition, the switchable valve is also connected to the control unit so that the control unit can influence or switch or control the switching state of the switchable valve. Preferably, the switchable valve or the switchable valves is a solenoid valve in order to achieve particularly simple and safe switching of the valve. Advantageously, the control unit is connected to a bus system, in particular a CAN bus system of the vehicle, on which the tire inflation system is arranged. This allows the control unit to transmit information to and/or receive information from other control units of the vehicle, in particular the commercial vehicle. The pressure sensor of the tire inflation system is arranged and/or designed in particular in such a way that it can detect a pressure at the flow outlet and/or at the flow inlet. Advantageously, this pressure detection can be limited to the static pressure and/or the pressure sensor can also be able to detect the dynamic pressure. Advantageously, the system has at least two pressure sensors, whereby one of these sensors determines or measures the pressure at the flow inlet and/or the other sensor measures the pressure at the flow outlet. These two sensors can therefore be referred to accordingly as the flow inlet sensor or the flow outlet sensor or the flow inlet pressure sensor and the flow outlet pressure sensor. Advantageously, these two sensors or all sensors, in particular pressure sensors, of the tire inflation system are connected to the control unit. The control unit is designed and/or configured in such a way that it opens and/or switches and/or closes the valve or the switchable valve or the valves or the switchable valves depending on the detected pressure. Expediently, the valve, which can also be referred to as a switchable valve, is arranged in the tire inflation system in such a way that, when the valve is open, an air flow can flow directly or indirectly from the flow inlet to the flow outlet through the valve (open position) and/or, when the valve is in any other switch position, the valve does not allow any air flow from the flow inlet to the flow outlet or can flow through the valve (closed position). The switchable valve can be arranged and/or designed in the tire inflation system such that the switch position of the valve determines whether a direct and/or indirect air flow can flow from the flow inlet to the flow outlet and/or an air flow from the flow outlet to the tire or tires to be inflated. By using a pressure sensor of a control unit and a switchable valve, it can be achieved that, in particular, the target pressure present in the tire can be variably adjusted, because the control unit can easily be set to the threshold value which must be exceeded and/or fallen below in order to open or close the valve. Conveniently, the valve or the switchable valve of the tire inflation system is designed in such a way that it has an electrical connection and/or is switched or can be switched by magnetic forces. This makes it possible to create a particularly compact and simple control option or switching option for the switchable valve.

Advantageously, all pressure sensors that are connected to the control unit are arranged between the flow inlet and the flow outlet. In other words, all pressure sensors that can transmit information to the control unit can be designed in such a way that they can only determine pressures between the flow inlet and the flow outlet. Therefore, the control unit is in particular not connected to a pressure sensor or to pressure sensors (in terms of information technology) that can measure the pressure in a tire or the air spring or the suspension system of the vehicle or can record it using measurement technology.

Advantageously, the control unit has an information output, wherein the control unit is designed to output a signal, in particular a warning signal, at the information output if the value determined by the or a pressure sensor of the tire inflation system or its time derivative is above a threshold value and/or below a threshold value. The warning signal can also be referred to as a warning signal. In particular, the information output of the control unit can be connected or connectable to a bus system and/or another information system of the vehicle. The warning signal output can therefore be used in particular to output a warning light and/or an acoustic or haptic signal for an operator of the commercial vehicle and/or the vehicle in which the tire inflation system is mounted. By designing the tire inflation system in such a way that it emits a warning signal at the information output if the pressure value detected in the tire inflation system at the flow inlet or outlet and/or its time derivative is above and/or below a threshold value, the user of the vehicle can be informed in a particularly simple way that there is an overpressure, underpressure and/or leakage and/or lack of operational readiness in the tire. The leakage can be determined in particular by the time derivative of the pressure. The overpressure and underpressure in the system and/or in the tire, on the other hand, can be easily detected by an “absolute” pressure measurement. In addition, the time derivative of the recorded pressure value, in particular at the flow inlet and/or at the flow outlet, can be used to detect whether, for example, a pressure increasing unit is operating properly. In other words, the pressure sensor can be used to determine the fluctuation of the pressure, which is a clear indication of, for example, a pump cycle of a pump and/or the opening time of the switchable valve in relation to a pressure change if no pump is present or if a pump or pressure booster unit has been bypassed. a pressure increasing unit is bypassed, whereby in addition or alternatively a long-term temporal value of the pressure is recorded and its temporal derivation, so that it can be determined whether the long-term increase in air pressure, in particular averaged over 2-40 seconds (moving average), is appropriate to the counted pump cycles. However, if the pressure increase does not correspond to the number of pumping cycles, the control unit can easily determine that there is a malfunction in the tire inflation system and/or in the tire and/or in the pressure supply system or at the flow inlet. In this way, the tire inflation system and its control unit can be used in a variety of ways to detect a malfunction of the tire inflation system and/or its surrounding components (tires and compressed air system) and/or to inform the driver of such a malfunction, in particular via the information output. The information output can be connected to a telematics system. The telematics can be used to inform a remote person. A remote person is a person who is more than 100 meters, preferably more than 1000 meters and particularly preferably more than 10 kilometers, away from the telematics. In particular, the remote person can be a fleet manager or a (fleet manager) server.

Advantageously, the control unit is an electronic control and/or monitoring unit. Such an electronic control and/or monitoring unit can also be referred to as an ECU and/or be designed as such. By providing the control unit in such a way that it is an electronic control and/or monitoring unit, an interface for a bus system of a vehicle can be realized in a particularly simple manner. In addition, such control units are also particularly cost-effective.

The valve, which is in particular a switchable valve or can be described as such, is expediently a solenoid valve. This allows the valve or switchable valve to be switched particularly easily and quickly.

Advantageously, the tire inflation system is designed in such a way that the pressure at the flow outlet is greater than at the flow inlet when the valve is open. In other words, the tire inflation system can increase the pressure between the flow inlet and the flow outlet. Such an increase in pressure can be present not only with an open valve but also with a closed valve. Advantageously, however, at least with an open valve, in a proper state, there is a higher pressure at the flow outlet than at the flow inlet. Such an increase in pressure between the flow inlet and the flow outlet can be achieved in particular by a pressure increasing unit.

Conveniently, the tire inflation system has a pressure increasing unit, wherein the pressure increasing unit is in particular a pressure booster. Alternatively, the pressure increasing unit can also be a pump, a pressure compensator, a pressure rocker, a peristaltic pump, a turbocharger and/or a turbine. By providing a pressure increasing unit, a higher pressure can be achieved in a simple and effective manner at the flow outlet than at the flow inlet. In other words, a pressure increasing unit can therefore be used to increase a pressure within the tire inflation system so that a low-pressure (air) system, in particular an air suspension system, of the vehicle can also be used as the inflation system of the tire inflation system and yet a sufficiently high pressure can still be present at the flow outlet. In particular, the pressure increasing unit can be connected to the control unit so that the control unit can control and/or regulate the pressure increasing unit. In other words, the control unit can specifically intervene in the (operating) state of the pressure increasing unit. If the pressure increasing unit is a pressure booster, a particularly compact system can be achieved which does not require any external connections, so that a particularly autonomous system can be achieved. If, on the other hand, the pressure increasing unit is a pump, a particularly cost-effective and simple design of the pressure increasing unit can be achieved. It is particularly preferable for the pressure increasing unit to be a peristaltic pump, as this means that contamination of the air with lubricants can be avoided, so that clogging of the tire valves of the tires to be inflated by lubricants can be prevented. Advantageously, the pressure increasing unit can be a turbocharger and/or a turbine. A turbocharger and/or a turbine can be used to achieve a continuous open pumping process so that the tire or tires can be filled almost without interruption. Advantageously, the turbocharger is fed by the compressed air system, which also feeds the flow inlet. If the pressure increasing unit is a pressure rocker, a further cost-effective alternative design of the pressure increasing unit can be achieved.

Preferably, the pressure increasing unit has an energy connection, whereby the energy required to increase the pressure enters or can enter the pressure increasing unit through the energy connection. Advantageously, the energy connection of the pressure increasing unit is connected to the flow inlet. In other words, the pressure increasing unit is supplied with energy via the flow inlet.

Advantageously, the pressure increasing capability or the pressure increasing ratio of the pressure increasing unit is in a range from 1.05 to 2.6, preferably in a range from 1.1 to 2.0, and particularly preferably in a range from 1.2 to 1.8. The pressure increasing capability or the pressure increasing ratio denotes the ratio between the inlet pressure and the outlet pressure of the pressure increasing unit or between the pressure at the flow inlet and the flow outlet. Alternatively or additionally preferably, the ratio may in particular also denote the ratio between the pressure at the outlet of the pressure increasing unit and the pressure at the inlet of the pressure increasing unit. With a ratio of 1.05 to 2.6, a particularly good range of use can be achieved, while at the same time preventing overloading of the system. If the ratio is in the range of 1.1 to 2.0, a particularly good utilization of the energy can be achieved or a particularly high degree of efficiency can be achieved.

Advantageously, the pressure increasing unit, which can in particular be a pressure booster, has one or two double pistons or double-acting cylinders or pistons. This allows a particularly compact design to be achieved. Advantageously, the two double-acting pistons or cylinders are mechanically connected to each other, in particular by a piston rod. This results in a particularly compact transmission of force between the pistons. A mechanical connection means in particular that the two elements cannot be separated from each other or moved relative to each other.

Advantageously, the pressure increasing unit has an outlet and/or a vent, whereby the outlet or vent connects the pressure increasing unit to the environment, in particular directly. This makes it easy to vent the pressure increasing unit. Advantageously, a silencer is arranged in or on the outlet or vent in order to reduce noise pollution in the surroundings. In addition to a direct connection, the or one of the switchable valves can also be arranged in the vent.

Preferably, the pressure increasing unit, which can in particular be a pressure booster, has a housing, whereby the housing is made of an aluminum alloy and/or a fiber-reinforced plastic or is at least partially made of such. The housing serves to protect the pressure increasing unit against external influences. The use of aluminum and/or fiber-reinforced plastic results in a particularly lightweight unit, which leads to an increase in payload, especially in commercial vehicles.

In an advantageous embodiment, the flow inlet is connected directly or indirectly to an inlet of the pressure increasing unit and/or wherein an outlet of the pressure increasing unit is connected directly or indirectly to the flow outlet. A direct connection means in particular that lines are routed directly from one element to the other element, in particular without a valve and/or a pump or other elements being arranged between them. With a direct connection, however, flow path forks or even valves, in particular only the switchable valve, can be provided without destroying a “direct” connection. An indirect connection means in particular that not only flow bifurcations can be present between the two relevant points to be connected, but also other elements, such as a pressure increasing unit and/or valves or other fluid mechanical elements. By connecting the flow inlet to the inlet of the pressure increasing unit, the pressure already present at the flow inlet can be used in a simple way so that the pressure increasing unit has to do less work. By connecting an output of the pressure increasing unit to the flow output, the fluid conveyed by the pressure increasing unit, in particular the compressed air, can be used for tire inflation in a particularly simple manner.

In an additionally or alternatively preferred embodiment, the pressure increasing unit has at least one, preferably two or a plurality of displacer element(s), in particular pistons in a cylinder head, advantageously in a double-acting cylinder. Displacement elements in the context of the invention are in particular those elements which are displaced and/or rotated within the pressure increasing unit in order to achieve a volume displacement and/or change in the delivery space of the pressure increasing unit and/or to achieve delivery of the delivery fluid, in particular compressed air. For example, pistons, turbine blades and/or variable hose volumes can therefore be described as displacement elements within the meaning of the invention. By providing displacement elements, an increase in pressure can be achieved by the pressure increasing unit in a particularly simple manner. Particularly preferably, the pressure increasing unit is a hydrostatic unit. In other words, the pressure increasing unit can be designed in such a way that it achieves the pressure increase through a closed thermodynamic process. Advantageously, the pressure increasing unit has one or more displacement elements in the form of one or more double-acting cylinder(s). It is expedient for two of these double-acting cylinders to be held and/or arranged on the same piston rod and/or connected to each other by an active connection, so that the movement of one double-acting cylinder automatically causes or necessitates a movement of the other double-acting cylinder. In this way, a pressure increasing unit, in particular in the form of a pressure booster, can be achieved in a particularly space-saving manner.

In an advantageous embodiment, the pressure increasing unit has a linear motor or is connected to a linear motor. By using a linear motor, a particularly good and compact drive option for the displacement element(s) and/or a piston of the pressure increasing unit can be achieved. In addition, a linear motor can also be used to specifically set and/or determine the stroke or displacement volume of the pressure increasing unit.

In an advantageous embodiment, the pressure increasing unit has a source of magnetic force, in particular an electromagnet, wherein the magnetic forces induced by the source of magnetic force act directly or indirectly on one or the displacement element of the pressure increasing unit, and advantageously can change the spatial position thereof. In other words, the pressure increasing unit can have an element which imitates or can induce magnetic forces, whereby the counterpart to this magnetic force source is directly or indirectly connected to a displacer element of the pressure increasing unit, so that the forces initiated by the magnetic force source can bring about a change in the spatial position of the displacer element of the pressure increasing unit. For example, the magnetic force source can be “similar” to a stator of an electric motor and the displacement element can be similar to a rotor of an electric motor. Therefore, in order to achieve a small size of the pressure increasing unit, it is particularly useful if the magnetic forces induced by the magnetic force source act directly on the displacement element of the pressure increasing unit, in particular a piston or a piston rod of the pressure increasing unit. By designing the actuation of the displacer elements or the drive of the displacer elements in this way, an operating principle similar to a “railgun” can be achieved, whereby the “projectile” can be the displacer element or form its equivalent.

Advantageously, the tire inflation system has a pressure input sensor, whereby the pressure input sensor is able to detect a pressure at the flow input. For example, the tire inflation system can have a further pressure sensor which is able to detect the pressure at the inlet of the tire inflation system. With such a pressure input sensor, the tire inflation system is able to detect the pneumatic operational readiness of the tire inflation system. In other words, the pressure input sensor can easily detect when there is insufficient air pressure at the flow input to operate the tire inflation system. The pressure input sensor is advantageously connected to the control unit of the tire inflation system so that the control unit can be fed or supplied with the value detected by the pressure input sensor.

Advantageously, the switchable valve is a 2/2-way valve. Alternatively or additionally preferred is the or one of the switchable valves a 3/2 way valve or a 4/2 way valve. By providing only two switching positions of the switchable valve, the valve can be switched relatively quickly and also reliably, so that the safety of the tire inflation system can be increased as a result.

If the switchable valve is a 2/2-way valve, a particularly compact valve can be achieved, saving valuable installation space.

If the switching valve is a 3/2-way valve, a targeted air flow from the flow inlet to the flow outlet can be achieved in different ways in a particularly simple design. For example, the tire inflation system can be designed in such a way that one of the connections of the 3/2-way valve is connected to the flow inlet and other connections are optionally or switchably connected to a connecting line and/or to the pressure increasing unit. This allows the type of pressure filling of the tire to be quickly and selectively adapted to the pressure present in the flow inlet. In particular, such a design allows the tire inflation system to selectively decide whether an air flow should be established directly between the flow inlet and the flow outlet—for example via a connecting line—or whether the (pressurized) air flowing from the flow inlet to the flow outlet should flow through the pressure increasing unit. By bypassing the pressure increasing unit, a particularly quick and easy filling can be achieved, whereby this should be used in particular if the pressure at the flow outlet is lower than the pressure at the flow inlet and/or if the required pressure is low, as may be the case with twin tires, for example.

If a 4/2-way valve is used, it can be achieved in particular that the pressure sensor, in particular the pressure input sensor, can be optionally connected to the environment or the flow input and at the same time the pressure increasing unit can be connected to the flow input or to the environment. By optionally connecting the pressure sensor in such a way that it is connected either to the flow inlet or to the environment, the pressure sensor, in particular the flow inlet sensor, can be used to detect a “sticking” of the switchable valve. In other words, the pressure sensor can therefore be used to monitor the correct function of the switchable valve. The selective distinguishability or connectability of the pressure increasing unit with the flow inlet or the environment can ensure that the tire inflation system continues to function even in the event of a malfunction of the pressure supply system, in particular the air suspension system, or a blockage of the flow inlet, because ambient air is therefore used to inflate the tire instead of the flow inlet.

Conveniently, the pressure sensor and/or the pressure sensors, in particular the pressure input sensor and/or the pressure output sensor, is/are arranged on a circuit board of the control unit. In this way, a particularly compact control sensor unit can be achieved, which can be easily mounted due to this compactness and only causes low storage costs during the manufacturing process and valuable installation space can also be saved.

Conveniently, the tire inflation system has a connecting line, whereby the connecting line directly connects the flow inlet, in particular exclusively via the valve, to the flow outlet. In other words, the tire inflation system can be designed in such a way that an air flow from the flow inlet via the connecting line and through the valve or through the switchable valve and through the connecting line connects the flow inlet directly to the flow outlet. In this way, a direct supply of air from the flow inlet into the tire can be achieved, in particular without guiding the air flow through the or a pressure increasing unit of the tire inflation system. This is particularly advantageous if a low tire pressure is to be quickly eliminated by the tire inflation system and/or if the tire inflation system or the flow outlet is fluidically connected to a dual tire. In addition, the inflation time and/or the energy requirement of the tire inflation system can be reduced by such a design-especially in the case of low tire pressure.

Conveniently, the tire inflation system has a drain valve, whereby the drain valve in one of its switching positions connects or can connect the flow outlet fluidically, in particular directly, to the environment. The drain valve can therefore serve to connect the flow outlet directly to the environment, in particular, in order to reduce the pressure within the tire inflation system, in particular at the flow outlet. The release valve can be connected to the control unit and/or be a self-switching valve. The advantage of a self-switching valve is that an additional safety system is created. The advantage of a release valve that can be switched by the control unit is that the tire pressure of the tire can be reduced in a targeted manner by the control unit using such a release valve. Such a measure may be necessary and/or preferable, for example, if the tire heats up considerably, if the road surface changes and/or if the tire is unintentionally overfilled with compressed air.

In an advantageous embodiment, the deflation valve can be switched by the control unit. This type of design makes it particularly easy to reduce the pressure in the tires in a targeted manner, in particular to a freely selectable value.

Conveniently, a back pressure valve and/or an overflow valve without backflow is/are arranged between the flow inlet and the switchable valve. By “between” it is to be understood that a back pressure valve and/or an overflow valve can be provided “in” a flow path between the flow inlet and the switchable valve. Therefore, the term “between” is to be understood in a flow sense. Advantageously, the backflow valve can prevent a flow of air or compressed air from the tire inflation system into the supply system, in particular the compressed air system of the supplying vehicle or commercial vehicle. In particular, this can prevent a loss of pressure. The overflow valve serves to ensure that a certain minimum inflation pressure is present at the flow inlet. It is expedient to provide both a back pressure valve and an overflow valve without backflow, as this double arrangement of both types of valve makes it possible to achieve a particularly safe and efficient tire inflation system.

Advantageously, the tire inflation system has a temperature sensor by means of which the ambient temperature or the compressed air temperature in the tire inflation system can be determined, in particular at the flow inlet. Advantageously, the tire inflation system can have a large number of temperature sensors.

Preferably, there is only one switchable valve between the flow inlet and the pressure increasing unit, in particular the inlet of the pressure increasing unit. This allows the pressure loss to be kept low, resulting in a particularly energy-efficient system.

Preferably, there is only one switchable valve between the pressure increasing unit, in particular the outlet of the pressure increasing unit, and the flow outlet. This allows the pressure loss to be kept low, resulting in a particularly energy-efficient system.

Advantageously, the switchable valve fluidically connects or disconnects the inlet of the pressure increasing unit from the flow inlet. In other words, the switchable valve or one of the switchable valves can fluidically connect the flow inlet to the pressure increasing unit, in particular the inlet of the pressure increasing unit, in one switching position and disconnect it in the other switching position. This allows a particularly compact system to be achieved.

Advantageously, the switchable valve fluidically connects or disconnects the outlet of the pressure increasing unit from the flow outlet. In other words, the switchable valve or one of the switchable valves can connect the flow outlet to the outlet of the pressure increasing unit—or generally the pressure increasing unit in terms of flow—in one switching position and disconnect it in the other switching position. This allows a particularly compact system to be achieved.

A further aspect of the invention may relate to a commercial vehicle comprising a tire inflation system as preceding and following. Advantageously, the flow inlet of the tire inflation system is connected or connectable to a compressed air system of the commercial vehicle, in particular to a compressed air system of an air spring of the commercial vehicle, and/or wherein the flow outlet of the tire inflation system is advantageously connected or connectable to a pressure chamber of a tire of the commercial vehicle. In other words, the tire inflation system can be arranged in the commercial vehicle in such a way that compressed air can flow from a compressed air system of the commercial vehicle via the flow inlet of the tire inflation system into the fluid interior or the flow lines and the compressed air-receiving structures of the tire inflation system and/or can flow or be conveyed from these volumes or compressed air-receiving volumes of the tire inflation system via the flow outlet of the tire inflation system into the pressure chamber of a tire of the commercial vehicle. Advantageously, all tires, especially load-bearing tires, of the commercial vehicle are fluidically connected to the flow outlet. For example, all tires of the commercial vehicle can therefore be inflated with the tire inflation system. The load-bearing tires of the commercial vehicle are in particular those tires that support the axles of the commercial vehicle. The axles are in particular those axles which support and/or carry the commercial vehicle relative to the road when the vehicle is traveling. These tires of the commercial vehicle can in particular be twin tires and/or single tires.

A further aspect of the invention may relate to a method of operating a tire inflation system, in particular as described above and below. Advantageously, this method comprises the steps of:
Determining the pressure at a flow outlet of the tire inflation system;
advantageously transmitting the determined pressure value to a control unit;
Comparison of the determined pressure with a target pressure by the control unit;
In particular, actuation of a pressure increasing unit of the tire inflation system, especially by the control unit, when the pressure is below the set pressure or a threshold value.

The method according to the invention is a particularly simple way of ensuring that if the pressure in the tire drops, the tire can be re-inflated or the pressure increased. Advantageously, the target pressure is a fixed value. In other words, this value is not variable. In particular, it is therefore not the tire pressure that is measured in the process, but only the pressure at the flow outlet. Alternatively or in addition to the flow outlet, the pressure at the flow inlet can also be measured.

In an advantageous embodiment of the method, this comprises the steps: Determining the delivered volume flow of a pressure increasing unit, in particular the tire inflation system;

Determine the increase in pressure at the flow outlet of the tire inflation system; Determine whether the pressure increase is less than the expected pressure increase, in particular due to the volume and/or the volume of the tires to be inflated and/or the volume of the tire inflation system.

By determining the volume flow delivered, in particular by counting pump cycles, pump strokes and/or revolutions and/or cylinder strokes of, for example, the displacement elements of the pressure increasing unit, and determining the increase in pressure at the flow outlet of the tire inflation system and comparing it with an expected pressure, it can be determined in particular whether a leakage and/or replacement of the tire(s) and/or the valve of the tire is required. The expected pressure increase can be determined in a simple way by knowing the provided volume of the tire inflation system and/or the tire and by using simple thermodynamic laws. Conveniently, this expected pressure increase or the determination of the delivered volume flow can be determined by the control unit of the tire inflation system.

In a further alternative or additionally preferred embodiment of the method of operating a tire inflation system, in particular as described above and below, the method comprises the steps of:
Determining the time between two consecutive pump cycles of the pressure increasing unit;
comparing the time and/or the change in time between two pumping cycles, whereby a warning is issued by the control unit if a threshold value is exceeded. By determining the times between two successive pumping cycles of the pressure increasing unit and comparing the change and/or with a set pressure, it can be easily determined whether the pressure increasing unit is functioning properly.

In particular, it can be determined that if the time interval between two successive pump cycles or pump strokes is too short, the desired target pressure difference cannot be achieved by the pressure increasing unit. Pumping cycles means in particular that a displacement element of the pressure increasing unit has completed exactly one running period or one revolution. In particular, a running period means that the displacement element of the pressure increasing unit has left a position and has returned to exactly the same position after one cycle.

In particular, the method according to the invention may have features that have already been described in the context of the tire inflation system and/or the commercial vehicle and/or are described below. In other words, the method for operating the tire inflation system may also have the features set forth above with respect to the device(s) and, conversely, the device may have features set forth in connection with the method for operating a tire inflation system. In particular, the control unit of the tire inflation system can be designed and/or constructed in such a way that it can implement the features according to the method, in particular in the tire inflation system described above and below.

### BRIEF DESCRIPTION OF THE DRAWINGS

Further advantages and features of the present invention are apparent from the following description with reference to the figures. Individual features disclosed in the embodiments shown may also be used in other embodiments, unless this has been expressly excluded. It shows:

FIG. 1 is a schematic view of a first embodiment of a tire inflation system;

FIG. 2 is a schematic view of a second embodiment of a tire inflation system;

FIG. 3 is a schematic view of a third embodiment of a tire inflation system;

FIG. 4 is a schematic view of a fourth embodiment of a tire inflation system;

FIG. 5 is a schematic view of a fifth embodiment of a tire inflation system;

FIG. 6 is a schematic view of a sixth embodiment of a tire inflation system;

FIG. 7 is a schematic view of a seventh embodiment of a tire inflation system;

FIG. 8 is a schematic view of an eighth embodiment of a tire inflation system;

FIG. 9 is a schematic view of a ninth embodiment of a tire inflation system; and

FIG. 10 is a schematic view of a tenth embodiment of a tire inflation system.

### DETAILED DESCRIPTION

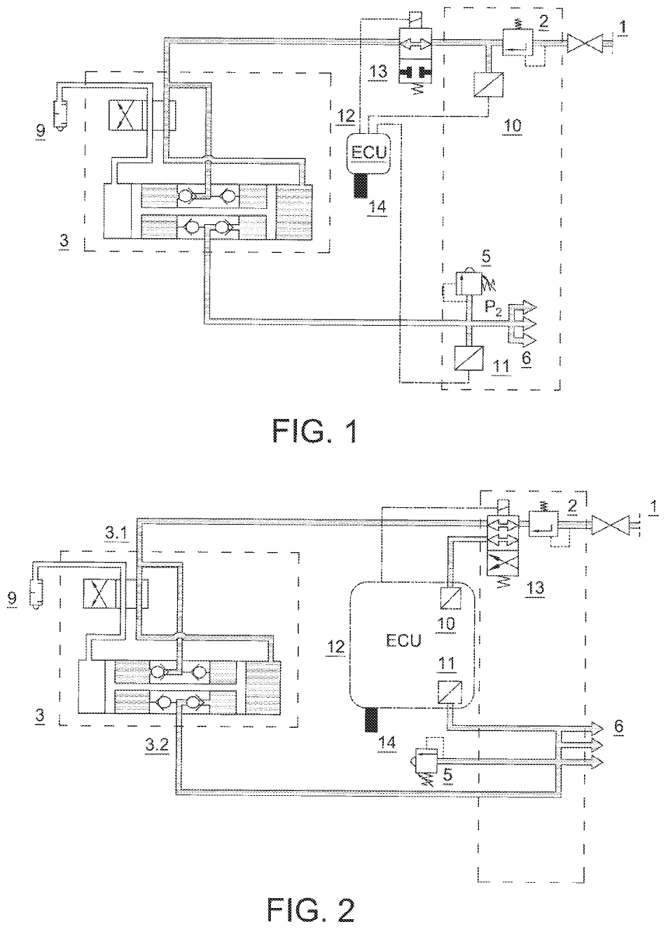

FIG. 1 shows a tire inflation system. The tire inflation system is connected to a compressed air system of a commercial vehicle via the flow inlet 1, whereby this system is an air spring compressed air system, which can also be referred to as the compressed air system of an air spring, of the commercial vehicle. This system can also be referred to as a filling or feed system. An overflow valve 2 is arranged downstream of the flow inlet 1 in the direction of flow. A flow branch is provided downstream of the overflow valve 2, through which the pressure sensor 11, which is a flow inlet sensor 11, in particular an indirect one, is able to determine the pressure at the flow inlet 1. Further downstream is the switchable valve 13, which can be switched by a current and an electromagnet. The switchable valve 13 is connected to the control unit 12 so that the control unit 12 can bring the switchable valve 13 into various switching positions. The control unit 12 has an information output 14. Via this information output 14, the control unit 12, which is an ECU in the figure, can supply information to a vehicle system, in particular via a bus system, to other control units of a vehicle and/or be connected to a display in order to be able to display error messages and/or other information, in particular pressure values of the pressure sensors 10, 11, for a user. In addition to or as an alternative to the information output 14, the control unit 12 can also have an information input through which information can be transferred to the control unit 12. In order to achieve a pressure increase compared to the pressure present at the flow inlet 1, which can be determined by the flow inlet sensor 10, the tire inflation system has a pressure increasing unit 3. In the present case, the pressure increasing unit 3 has two double-acting cylinders, which are coupled to each other via a piston rod. The pressure increasing unit 3 has an ambient outlet at which a silencer 9 is arranged. A fluid can be discharged from the pressure increasing unit 3 directly into the environment via this ambient outlet. The outlet of the pressure increasing unit 3 is directly connected to the flow outlet 6, whereby the flow outlet 6 is connected to several tires, as indicated in FIG. 1. In order to determine the pressure present at the flow outlet 6, the tire inflation system has a pressure sensor 11, which is designed as a flow outlet sensor 11, as this determines the pressure at the flow outlet 6, as can be seen from FIG. 1. In order to prevent overloading of the system due to excessive pressure in the lines of the tire inflation system, a safety valve 5 is installed or arranged in the vicinity of and/or directly connected to the flow outlet 6, which can prevent excess pressure in the system. Alternatively or additionally preferably, the safety valve 5 can also be integrated into the pressure increasing unit 3, in particular in such a way that it is directly connected to the outlet 3.2.

FIG. 2 shows a system similar to that shown in FIG. 1, whereby the input of the pressure increasing unit 3.1 and the output of the pressure increasing unit 3.2 are characterized in FIG. 2. As can be seen in FIG. 2, both the flow input sensor 10 and the flow output sensor 11 are part of the control unit 12. This control unit 12 can also be referred to as a control device. The switchable valve 13 used in FIG. 2 is a 4/2-way valve. In the situation shown in FIG. 2, the pressure input sensor 10 is connected to the environment via the switchable valve 13, so that a “sticking” of the switchable valve 13 can be detected via the pressure sensor 10 or the flow input sensor 10.

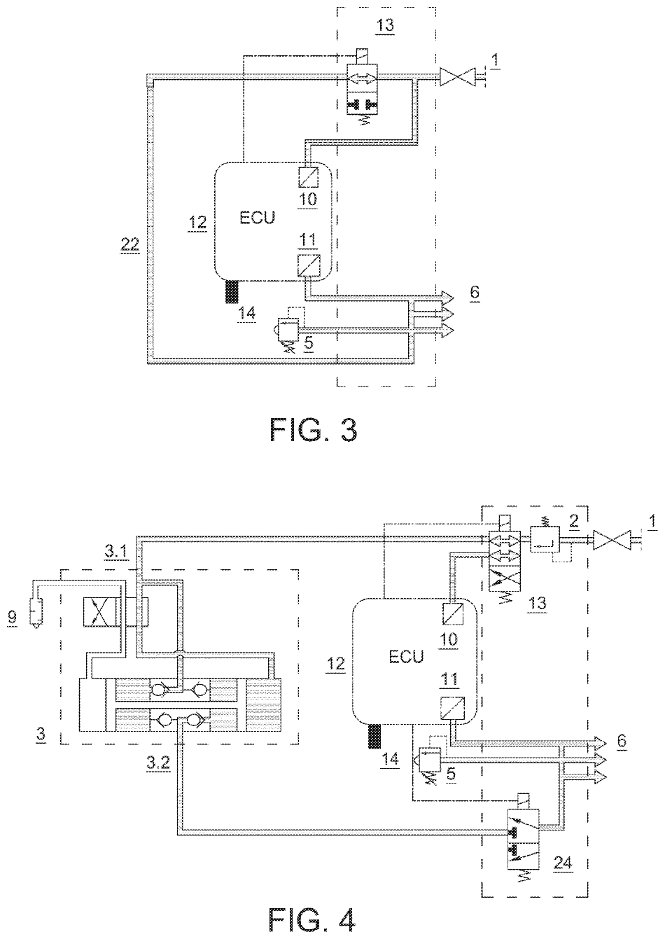

FIG. 3 shows a tire inflation system that differs fundamentally from the variants shown in FIGS. 1 and 2. In the variant shown in FIG. 3, the flow inlet 1 is directly connected to the flow outlet 6 via the connecting line 22. Therefore, the tire inflation system shown in FIG. 3 does not have a pressure increasing unit.

FIG. 4 shows a tire inflation system similar to the tire inflation system shown in FIG. 2, wherein the system according to FIG. 4 comprises a deflation valve 24 which is switchable by the control unit 12. In other words, the control unit 12 can therefore bring the drain valve 24 into its two different switching positions. In FIG. 4, the drain valve 24 is designed as a solenoid valve. The drain valve 24 can easily reduce the pressure at the flow outlet 6 in order to prevent over-inflation of the tire or the tires to be inflated or to reduce the pressure in the tire.

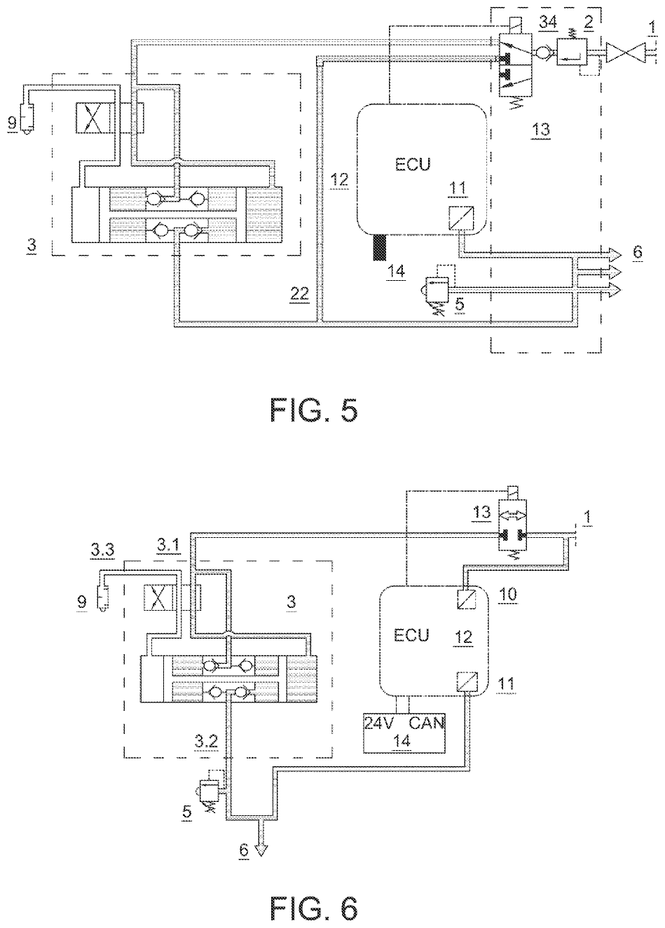

FIG. 5 shows a tire inflation system which, by means of the switchable valve 13, is capable of connecting the flow inlet 1 to the flow outlet 6 via the pressure increasing unit 13 or via the connecting line 22. In other words, the switchable valve 13 switched by the control unit 12 can therefore ensure that an air flow from the flow inlet 1 flows through the pressure increasing unit 3 to the flow outlet 6 or can flow directly from the flow inlet 1 or the switchable valve 13 via the connecting line 22 to the flow outlet 6. In addition, an overflow valve 2 and a back pressure valve 34 are located between the switchable valve 13 and the flow inlet 1, whereby the back pressure valve 34 serves to prevent fluid from flowing back from the inside of the tire inflation system to the flow inlet 1. The overflow valve 2, on the other hand, serves to ensure that the compressed air at flow inlet 1 has a certain minimum pressure.

FIG. 6 shows a tire inflation system. The tire inflation system has a pressure increasing unit 3 with an input 3.1 and an output 3.2. The information output 14 of the control unit 12 is connected to a 24V CAN bus or forms such a bus—at least in part. However, the CAN bus can also have a lower voltage, e.g. 12 volts or 5 volts. This CAN bus can be provided in any embodiment of the invention. The pressure increasing unit 3 is connected to the environment via a vent, the vent having a silencer 9, which can also be referred to as a silencer. The switchable valve 13 is connected to the control unit 12, whereby the switchable valve 13 is a 2/2-way valve. The 2/2-way valve or the switchable valve 13 is located in a supply line of the pressure increasing unit 3 or connects or separates the inlet 3.1 of the pressure increasing unit 3 from the flow inlet 1 in terms of flow. Both the flow inlet 1 and the flow outlet 6 are each connected to a pressure sensor so that the pressure can be measured or recorded there.

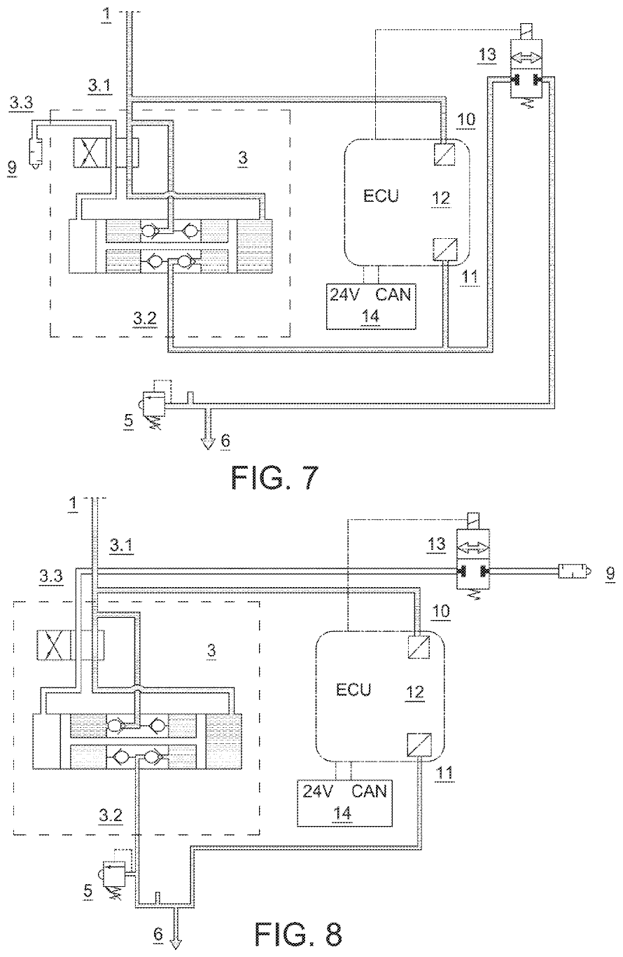

FIG. 7 shows an embodiment similar to FIG. 6. The switchable valve 13 is also connected to the control unit 12, whereby the switchable valve 13 is a 2/2-way valve. The 2/2-way valve or the switchable valve 13 is located in a drain of the pressure increasing unit 3 or connects or separates the outlet 3.2 of the pressure increasing unit 3 from the flow outlet 6 in terms of flow. Both the flow inlet 1 and the flow outlet 6 are each connected to a pressure sensor 10, 11, so that the pressure can be measured or detected there.

FIG. 8 shows a design similar to FIG. 6 or 7. However, the switchable valve 13 is arranged here in the vent of the pressure increasing unit 3.

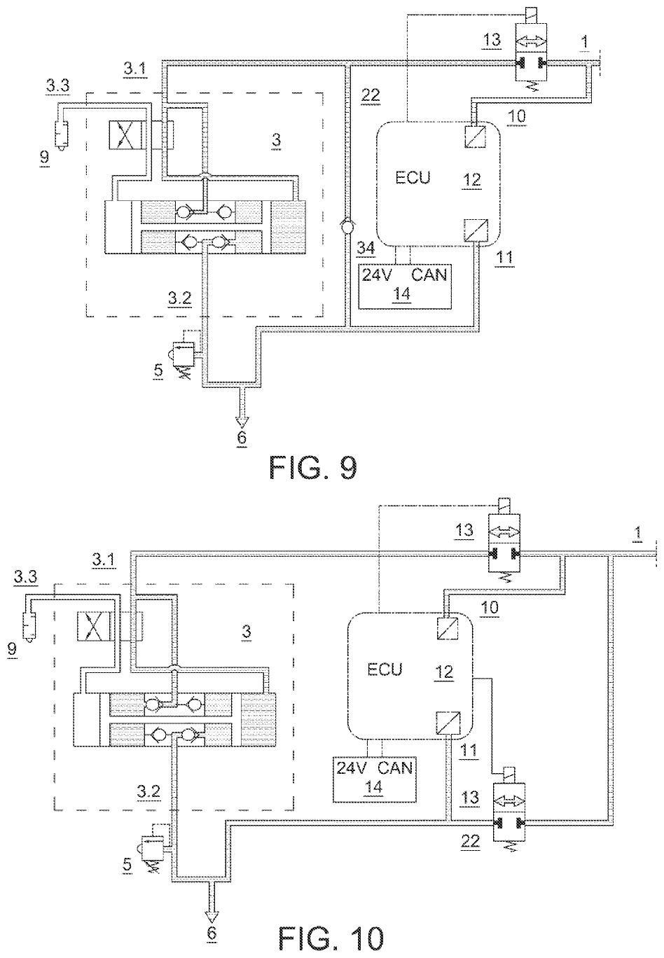

FIG. 9 shows a further embodiment of a tire inflation system. Similar to the embodiment in FIG. 5, this tire inflation system has a connecting line 22 which can connect the flow inlet 1 directly to the flow outlet 6, thus bypassing the pressure increasing unit 3. In order to prevent a backflow through the connecting line 22, a back pressure valve 34 is arranged inside the connecting line 22. The switchable valve 13 can connect the connecting line 22 as well as the pressure increasing unit 3 to the flow inlet 1 or disconnect both at the same time. Advantageously, in the embodiment shown, the desired pressure at the flow outlet 1 is not more than 15% lower than the desired tire pressure or the pressure at the flow outlet 6.

FIG. 10 shows a further embodiment of a tire inflation system. This embodiment is characterized in particular by the fact that a switchable valve 13 is arranged in the connecting line 22 as well as in the supply line to the pressure increasing unit 3. This makes it possible to counteract even large leakages of a tire, in particular through the connecting line 22. The connecting line 22, which can also be referred to as a bypass, can also be equipped with a switchable valve and/or a back pressure valve 34 in other embodiments.

### LIST OF REFERENCE SYMBOLS

1—Flow inlet
2—Overflow valve
3—Pressure increasing unit
3.1—Pressure increasing unit input (3)
3.2—Pressure increasing unit output (3)
5—Safety valve
6—Flow outlet
9—Silencer
10—Pressure sensor/flow input sensor
11—Pressure sensor/flow output sensor
12—Control unit
13—Switchable valve
14—Information output
22—Connecting cable
24—Drain valve
34—Back pressure valve

1.-15. (canceled)

16. A commercial vehicle comprising a tire inflation system, where the commercial vehicle includes a commercial vehicle trailer, the tire inflation system, comprising:
a control unit, a flow inlet, a pressure sensor, a switchable that is electrically or magnetically switchable valve and a flow outlet;
wherein the flow inlet is configured to be connected to a compressed air system of an air spring;
wherein the flow outlet is configured to be connected to a pressure chamber of a tire;
wherein the control unit is connected to the pressure sensor and the switchable valve;
wherein the pressure sensor is configured to detect a pressure at the flow outlet or at the flow inlet;
wherein the control unit is configured such that the control unit opens and/or switches the switchable valve as a function of the detected pressure when the detected pressure at the flow outlet falls below a threshold value; and
wherein the tire inflation system has a pressure increasing unit that includes a pressure booster having one or two double pistons or double-acting cylinders or double-acting pistons.

17. The commercial vehicle according to claim 16, wherein the control unit comprises an electronic control and/or monitoring unit.

18. The commercial vehicle according to claim 16, wherein the pressure increasing unit includes an energy connection, the energy required to increase the pressure reaching or being able to reach the pressure increasing unit through the energy connection, and wherein the energy connection of the pressure increasing unit is connected to the flow inlet.

19. The commercial vehicle according to claim 16, wherein a pressure increasing ratio of the pressure increasing unit is in a range from 1.05 to 2.6.

20. The commercial vehicle according to claim 19, wherein the ratio is in a range of from 1.1 to 2.0.

21. The commercial vehicle according to claim 20, wherein the ratio is in a range of from 1.2 to 1.8.

22. The commercial vehicle according to claim 16, wherein the tire inflation system has a pressure input sensor configured to detect a pressure at the flow input.

23. The commercial vehicle according to claim 16, wherein the switchable valve comprises a 2/2-way valve.

24. The commercial vehicle according to claim 16, wherein the switchable valve comprises a 3/2-way valve.

25. The commercial vehicle according to claim 16, wherein the switchable valve comprises a 4/2-way valve.

26. The commercial vehicle according to claim 16, wherein the pressure input sensor is arranged on a circuit board of the control unit.

27. The commercial vehicle according to claim 16, wherein the tire inflation system further comprises a connecting line that connects the flow inlet to the flow outlet via the switchable valve.

28. The commercial vehicle according to claim 16, wherein a back pressure valve and/or an overflow valve without backflow is/are arranged between the flow inlet and the switchable valve.

29. The commercial vehicle according to claim 16, wherein the flow inlet is configured to be connected to the compressed air system of the air spring of the commercial vehicle, and/or wherein the flow outlet is configured to be connected to a pressure chamber of a tire of the commercial vehicle.

30. The commercial vehicle according to claim 16, where the commercial vehicle trailer comprises a semitrailer.

31. A method of operating a tire inflation system of a commercial vehicle trailer according to claim 16, comprising:
determining the pressure at a flow outlet of the tire inflation system;
comparing the determined pressure with a target pressure by a control unit; and
actuating the pressure increasing unit of the tire inflation system when the determining pressure is below the target pressure.
